(19) United States
(12) Patent Application Publication
(10) Pub. No.: US 2013/0346167 A1
(43) Pub. Date: Dec. 26, 2013

(54) UNIFIED LOYALTY PROGRAM MEDIA

(71) Applicant: Marco A. Telles, Key Biscayne, FL (US)

(72) Inventor: Marco A. Telles, Key Biscayne, FL (US)

(21) Appl. No.: 13/760,685

(22) Filed: Feb. 6, 2013

Related U.S. Application Data
(63) Continuation-in-part of application No. 12/734,524, filed on Jul. 6, 2010, now abandoned.
(60) Provisional application No. 60/987,776, filed on Nov. 14, 2007.

(51) Int. Cl. G06Q 30/02

(52) U.S. Cl. CPC G06Q 30/0229
USPC 705/14.3

(57) ABSTRACT

The present invention generally relates to a media that incorporates several distinct rewards/relationship/fidelity/loyalty programs, and/or other sorts of information into a single media, particularly, but not limited to, a card, making it easier for the user who typically carries and uses several such cards or media, in a simple and convenient way. The invention concerns a method of creating such a single media, as well as the single media itself.

### CLAIM OF PRIORITY

The present application is a Continuation-In-Part application of previously filed, now pending application having Ser. No. 12/734,524 which was filed on Jul. 6, 2010, which is a nonprovisional U.S. national patent application filed under 35 U.S.C. §371 and claiming priority to international application filed under the Patent Cooperation Treaty having International Application No. PCT/BR2008/000348 filed in Brazil on Nov. 13, 2008, which claims priority to provisional application having U.S. Application Ser. No. 60/987,776 filed on Nov. 14, 2007, the contents of which are all incorporated herein by reference in their entireties.

### FIELD OF THE INVENTION

The present invention generally relates to a media that incorporates several distinct rewards/relationship/fidelity/loyalty programs, and other sorts of personal information into a single media, making it easier for the user who typically carries and uses several such cards or media, in a simple and convenient way. The invention concerns a method of creating such a single media, as well as the single media itself.

### BACKGROUND OF THE INVENTION

As used herein, the terms “rewards program”, “relationship program”, “fidelity program”, “loyalty program”, “program” and “membership” may be used interchangeably, and each shall mean any program, membership, club or any other customer identifier method, offered by a third party business where the customer/member is enrolled, is part of or benefits from. As used herein, the term “provider” shall mean the entity, for instance company or business, that provides the services related to the unified media of the invention, such as creating, managing and/or distributing the unified media. As used herein, the terms “user”, “customer”, “member”, “cardholder”, “customer/member”, “client”, “account holder”, may be used interchangeably with each other, and each shall mean the individual or business that is enrolled, part of or benefits from any loyalty program. They may also mean the individual or business that is already part of the provider's database. As used herein, the terms “unified media”, “unified card”, “consolidated card”, “source”, “single source”, “media”, “booklet”, “card”, may be used interchangeably, and each shall mean the end product of this invention, which is any form, shape and/or material, (such as, but not limited to, plastic, paper, metal, resin, and others) capable of holding and representing user information.

As used herein, the term “network” shall mean any data network, such as, but not limited to, a local area network (LAN), a wide area network (WAN), a payment network, a global computer network such as the Internet, a cardholder-accessible network, interactive television (ITV) network, internet-based, other existing network architectures or any network architecture yet to be developed. “Conventional communication transmission” expresses means such as, but not limited to, by wire, wireless, satellite, radio frequency, cable, DSL, fiber optic cables or any combination of these or other communication means. In today's economy, people often seek for opportunities to be rewarded, in some way, by the businesses they frequently use. A very common and popular way of being rewarded and recognized is by participating in the numerous reward, relationship, loyalty and fidelity programs in the market, such as ExtraCare® by CVS and Work Life Reward® by Office Depot, among thousands of others. Further, the need for a customer of such programs to carry a large quantity of program cards, suddenly becomes a burden, since a single customer in the USA, in average, carries 5 different fidelity/rewards cards in his/her wallet at all times. FIG. 1 depicts an example of such prior art. Even though fidelity/reward cards are lightweight and easy to carry in a key chain or wallet, the more programs a user is part of, the more space it will take in his/her wallet or key chain.

The various aspects of the present invention concerns a unified media for fidelity/reward programs, a method of unifying them, a method of using such unified media, and other aspects that will become apparent along the following description.

### SUMMARY OF THE INVENTION

In the text that follows, for ease of reference, any mention to “card” is not limitative, and should be understood as representative of any equivalent media.

The present invention generally concerns a unified media that holds information on more than two, or a plurality of, loyalty programs.

The invention also concerns a method for physically unifying or combining all of ones fidelity/rewards cards into a unified media, for instance a card, allowing a user to carry significantly less cards than the present number they usually carry, typically only one single media that physically contains all the information for his/her several member programs.

In another aspect, the present invention relates to a method for a user to obtain—ordering online, by mail, by phone, in person at kiosks or any other communication method currently available or to become available—a unified media that holds several fidelity program member information, such as (but not limited to) barcodes, magnetic stripes, personal information and others. In a particular embodiment, the invention media is able to hold information accessible on both sides.

The method for obtaining the invention media comprises grouping one or more, or at least one, identification means for two or more, or a plurality of, fidelity program (for instance barcodes, magnetic stripes) into one single media (e.g. card) that will contain all such identification means, available so as to allow the information to be used and to be read by each one of the businesses that need the information contained therein, and also in a way that will fit into a regular credit card size wallet slot/pocket. The unified media of the invention may additionally contain further information, such as, but not limited to, personal, emergency and/or medical information. The unified media of the invention is not limited to any specific shape, weigh, or material.

### BRIEF DESCRIPTION OF THE DRAWINGS

FIG. 1: is a draft representation of the prior art, i.e., several loyalty cards an individual carries on a day-to-day basis, in his/her wallet and/or key-chain.

FIG. 2: is a draft representation of a unified card according to the invention. It is illustrated the front and back of a card just as reference.

FIG. 3: is a draft representation of the reading mask, according to a particular embodiment of the invention.

FIG. 4: is a diagram of an embodiment of the method of the present invention.

FIG. 5: is a diagram of one embodiment of the method of changing the status of an existing unified media by adding at least one loyalty card.

FIG. 6: is a diagram of another embodiment of the method of changing the status of an existing unified media by deleting at least one loyalty card.

### DETAILED DESCRIPTION OF THE PREFERRED EMBODIMENT

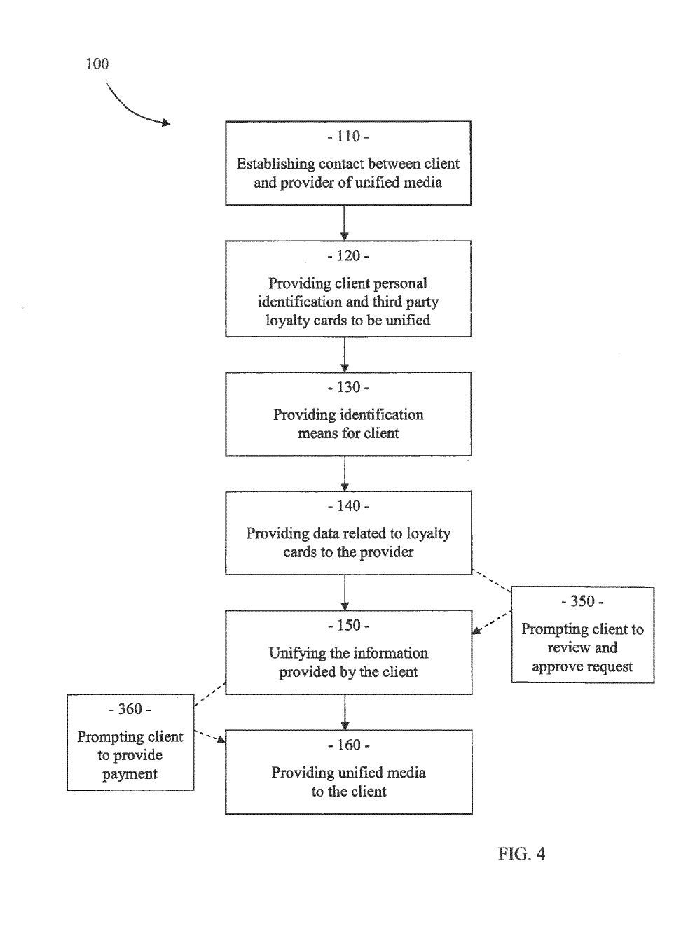

In one aspect shown in FIG. 4, the invention concerns a method 100 of unifying two or more, or a plurality of, fidelity programs in one single media, according to the following steps: a. establishing contact is established between a client and a provider of unified media, as at 110; b. providing client provides personal identification and his/her third party fidelity programs to be unified, to said provider, as at 120; c. providing said provider provides identification for said client, as at 130; d. providing said client provides the means that contain data related to the fidelity programs to said provider, as at 140; e. unifying said provider unifies information on a unified media, as at 150; and f. providing said provider provides unified media to client, as at 160.
a. contact is established between a client and a provider of unified media;
b. said client provides personal identification and his/her third party fidelity programs to be unified, to said provider;
c. said provider provides identification means for said client;
d. said client provides the means that contain data related to the fidelity programs to said provider;
e. said provider unifies information on a unified media;
f. said provider provides unified media to client.

In order to benefit from this invention the customer gathers all or several of his/hers programs cards/memberships and submits this information (electronically, in person, or through any other equivalent means) to the provider, with which develops, customizes, layouts, creates and delivers to the customer/member a unified media, particularly a card, containing all desired programs information (such as barcodes and/or magnetic stripes and/or equivalents) in a single card. This process may be achieved, but not limited to, online through a network, over the phone, in person, via fax, via IPTV and/or via regular mail.

In step a above, establishing contact 110, the contact established between a client and a provider of unified media can be personal, by mail, by telephone, through a network, particular on the internet, or any equivalent means. The client may contact the provider, or vice versa.

In step b above, providing client personal information 120, the client provides personal information such as, but not limited to, name, address, telephone, e-mail address, social security number, bank account number, etc. The client may also provide further information to be contained in the unified media, such as medical information, emergency data, insurance data, telephones and addresses of people to contact in any desired event. That information may be simply printed on the unified media, or be accessible by electronic means, such as a barcode, a magnetic stripe, a RFID tag, or any equivalent means.

In step c above, providing identification 130, the identification the provider provides to the client may be of any kind, particularly a login name and a password to be used over a network such as the internet, where the client may check, for instance, information or status of his/her unified card, in a site containing such information.

In step d above, providing data 140, the means that contain data related to the existing fidelity programs to unify, and the data provided are, for instance, cards, barcodes, numbers associated with barcodes, magnetic stripes, chips, RFID tags, etc.

In step e above, unifying the information 150, the provider has the information desired by the client unified in a media, with the necessary means, such as electronical, mechanical, chemical, or any other.

In step f above, providing unified media 160, the provider provides unified media to the client by any adequate way, for instance local manufacture, delivery by mail, personal delivery, or any equivalent.

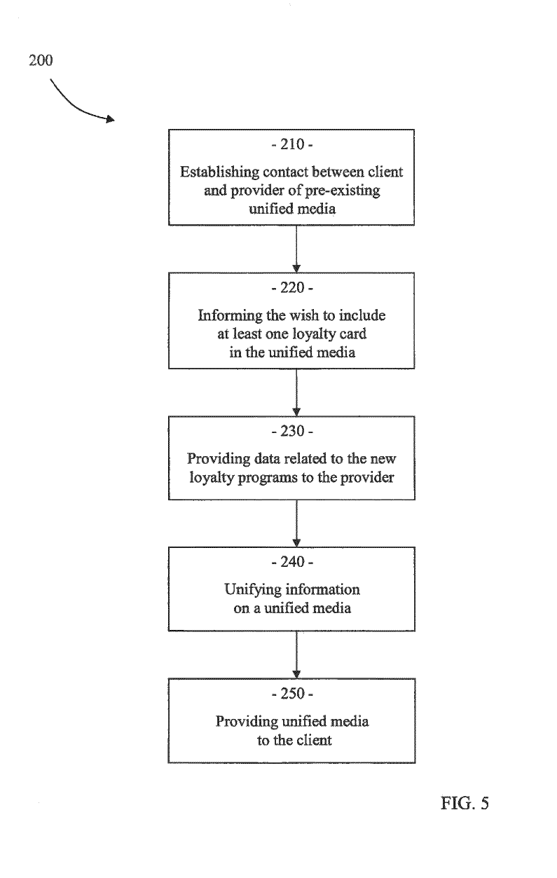

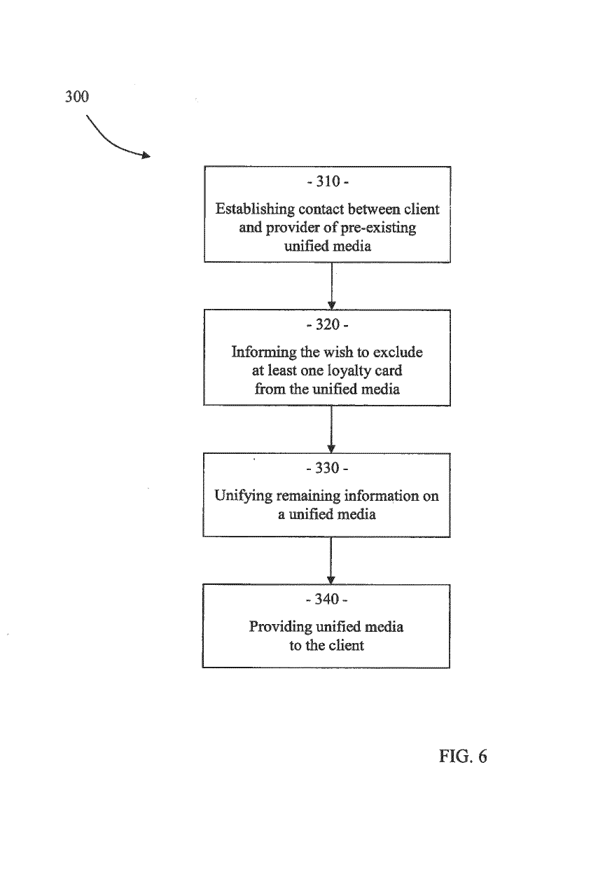

The method above can be adequately modified if a prior unified media is already possessed by the client, who wants to alter the status of the media—steps b and c are replaced by a single step, according to which said client informs what changes are wanted in the unified media. For instance, as depicted in FIG. 5 as method 200, if the change relates to including one or more programs in the unified media, the method 200 includes informing the wish to include at least one loyalty card in the unified media, as at 220, and providing data related to the new loyalty programs or cards to the provider, as at 230, and steps d and e remains the same. If the client wants to remove specific information, or one or more programs from the unified media, as shown in FIG. 6 and method 300, and at least two programs still remaining on the unified media, item d is removed, and the method 300 includes informing the wish to exclude at least one loyalty card from the unified media, as at 320. As to item f above, providing unified media to the client, as at 250 in FIG. 5 and as at 340 in FIG. 6, in any of the above options concerning change, the unified media provided by the provider can be different from the one already possessed by the client.

The method of the invention may also comprise steps according to which, before the provider provides the unified media to the client, or before the provider unifies the client's information on a unified media, prompting the client to review and approve his/her request, as at 350, and/or prompting the client to provide advance payment, as at 370, or any other form of payment, as at 360.

It should be understood that the various pieces of information in the text and in the examples herein, as well as in the attached drawings, are not to be construed as limiting the invention, for instance concerning the order in which the individual process steps may be performed.

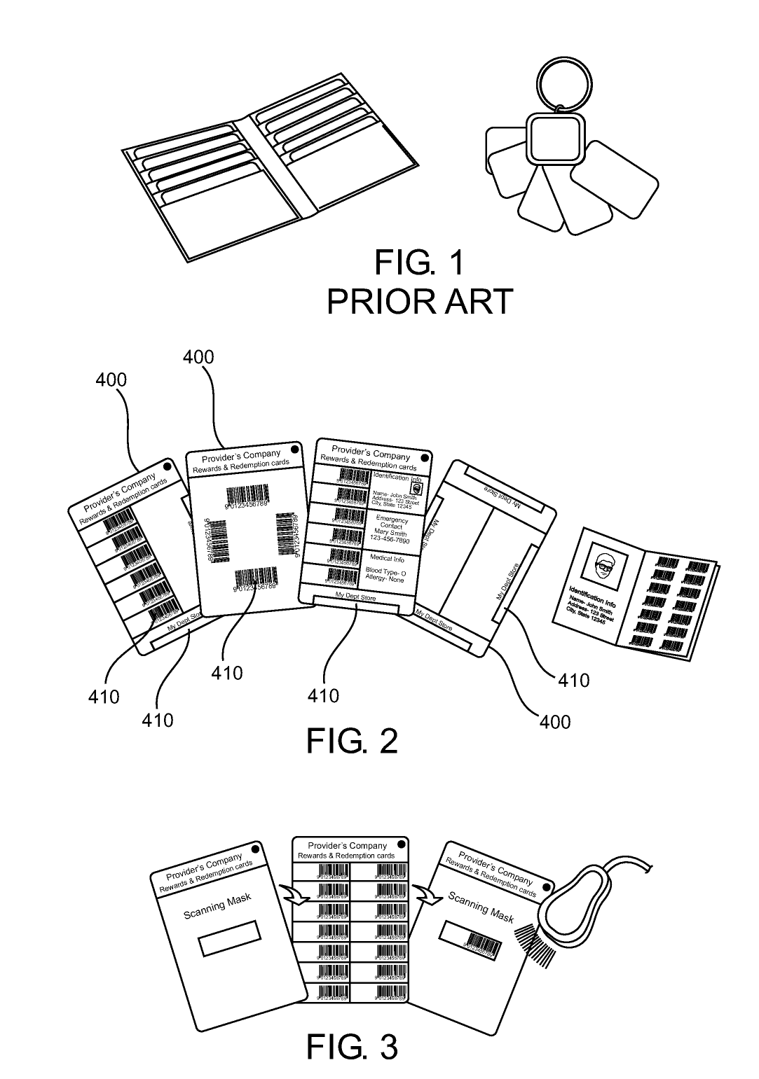

Another aspect of the invention, as depicted in FIG. 2, concerns a unified media 400 containing identification 410 of at least two, or a plurality of fidelity programs, available for a user who possesses such unified media, to be used in connection with the at least two or plurality of fidelity programs. As FIG. 2 shows, the plurality of identification 410 of the fidelity programs may be arranged in various orientations on the unified media 400.

In a particular embodiment of the invention, in order to help a barcode scanner to read a specific loyalty program barcode 410 from the unified card 400, without interference from the neighbor barcodes 410, or if any difficulty is presented at the time of scanning the code within the unified card 400, a cover sheet (cover-card or any other material) may be provided for that purpose. The referenced cover-card is a substrate with a window or aperture on it, therefore working as a mask, to allow only one specific barcode to be scanned at a time. FIG. 3 is an illustration of a reading mask to help a barcode scanner to read a single barcode.

### EXAMPLES

The following examples aim at presenting specific embodiments of the inventions, without limiting the scope of the attached claims:

### Example 1

### Method with Online Ordering (Through a Network)

i. Customer uses a network to access the provider world wide web homepage;

ii. The provider homepage may optionally contain general information about the product/services, as well as a restricted area for customers only;

iii. If the customer has never used the provider's services, it will be required to login by providing a unique identifier (such as electronic mail (email) address, or user-name); If the customer already has a profile created within the provider's database, it will be required to enter his/her unique identifier on file and the formerly created password;

iv. Once the login has been successfully completed, the customer may be prompted to choose from a set of products offered, which may vary from a distinct number of barcodes card types, distinct number of barcode and magnetic stripes card types and others;

v. By selecting the product wanted, the customer may begin the upload process of his/her own personal information (barcodes, medical information, etc), by typing each one of the loyalty programs barcodes numeric representation into separate fields, and selecting the name of the third party business they were issued by, if possible a corresponding logo, and/or any additional information, if desired to do so;

vi. During the above data entering/upload process, the customer may save the information entered, at any time, to continue the unified card creation process during a later time. In order to save the information, the customer is required to fill out a basic personal profile, and choose a password, in order to be able to re-enter the website and access his/her private information;

vii. Once the information entering/uploading process has been completed, the card type has been chosen, and the customer is ready to submit its order for the unified card creation, the customer is prompted to validate and confirm all information input, than the system uses an e-commerce platform, and prompts the customer for payment and delivery options, through a secured connection, presenting all shipping and handling details;

viii. If all payment and delivery information have been properly entered and approved, the unified card will be issued and mailed to the customer, according to a previously stipulated timeframe;

ix. The customer may exit the website and choose to save all his/her information for further use;

x. If the customer needs to access his/her account within the provider to re-issue, to update, to add more loyalty programs, to delete any information and/or manage any or all of his/her information, the customer needs to login using his/her credentials to proceed with the intended purpose.

### Example 2

### Method with Regular Mail Ordering

i. Customer obtains and fills out a mail order form from the provider, for instance available through local distributors, on the provider's network homepage, via fax, by mail upon request or other equivalent mechanisms;

ii. Along with the mail order form, the customer may either fill out each and every barcode numeric representation on the appropriate fields of the form, or may attach a photocopy of each one of the loyalty cards to be unified;

iii. In case of ordering a magnetic striped unified card, the customer submits its original loyalty program magnetic card, from which the provider will read the magnetic stripe content and unify it along with other cards and information provided for this purpose. In this particular case, the provider may accept certified mail with proof of delivery, in order to protect the customers original magnetic stripe cards;

iv. Once the mail order form has been successfully received and processed, the unified card is issued and mailed to the customer, including a username for the customer and password instructions;

v. All payment, including shipping, handling and billing information are filled out on the mail order form in order for the order to be released; In case original magnetic stripe cards have been submitted, they are returned to the customer along with his/her order delivery, for instance using certified mail with proof of delivery;

vii. If the customer needs to access his/her account within the provider to re-issue, to update, to add more loyalty programs, to delete any information and/or manage any or all of his/her information, the customer submits a new mail order form (or calls the customer service line or accesses his/her account online), requesting the appropriate and specific actions to be taken by the provider.

### Example 3

### Method with Telephone Ordering

Customer calls the provider's telephone number (local and/or toll free);

ii. One or more telephone numbers to contact the provider may be available through local distributors, on the provider's network homepage or other equivalent mechanisms;

iii. Once the customer has reached the provider's customer service line, he/she will select from a menu of options, among them being a new customer or a current customer;

iv. Once the provider, for instance through a customer service representative, has clarified any doubts the customer might have, and collected the information required for the unified card creation, if an order is placed, the unified card is issued and mailed to the customer;

v. In case of ordering a magnetic striped unified card, the customer needs to submit its original loyalty program magnetic card—for instance according to the customer service representative instructions—from which the provider will read the magnetic stripe content and unify it along with other cards provided for this purpose.

In this particular case, the provider preferably accepts certified mail with proof of delivery, in order to protect the customers original cards;

vi. All payment, including shipping, handling and billing information is collected and verified by the customer service representative in order for the order to be released; In case original magnetic stripe cards have been submitted, they are returned to the customer along with his/her order delivery, using certified mail with proof of delivery;

vii. If the customer needs to access his/her account within the provider to re-issue, to update, to add more loyalty programs, to delete any information and/or manage any or all of his/her information, the customer needs to call in, or to submit a new mail order form or to access his/her account online, requesting the appropriate and specific actions to be taken by the provider.

### Example 4

### Method with in Person Ordering on a Kiosk

i. Customer visits a self-service kiosk or an automated kiosk, for instance made available at public places, associated stores, shopping malls and other places;

ii. Once the customer has access to the kiosk he/she needs to follow the quick guide step-by-step instructions and/or also on screen step-by-step procedures;

iii. Once the how to use step-by-step has been followed, the customer is able to type in and/or scan/read each and every loyalty programs barcodes/magnetic stripes or its numeric representation, into separate fields, select and/or type in the name of the third party business they were issued by, if possible a corresponding logo, and/or any additional information, if desired to do so;

iv. Once the data entering/upload process has been completed, the card type has been chosen, and the customer is ready to confirm its order for the unified card creation, the system prompts the customer for payment and delivery options, which may consist of just-in-time delivery or later mail delivery, presenting all shipping and handling details as appropriate;

v. If all payment and delivery information has been properly entered and approved, the unified card 400 is issued at the very moment or mailed to the customer, according to the customer selection;

vi. The customer may exit the kiosk and choose to save all his/her information for further use on other kiosks, on the provider's website, via telephone, or other mechanisms;

vii. If the customer needs to access his/her account within the provider's network site to re-issue, to update, to add more loyalty programs, to delete any information and/or manage any or all of his/her information, the customer needs to login using his/her credentials to proceed with the intended purpose.

Any combination of the above processes or its parts and/or other ordering mechanisms, may be used in order to achieve the present invention.

As will be fully appreciated by those of skill in the art, the present invention is concerned with one or more of the following functions: a new media capable of consolidating several loyalty programs and other information into a unified card 400, an infrastructure, physical and/or logical, for any consumer or member to successfully use this invention; the ability for the member to access the service through a site directly or through linkages or hyperlinkages from other host sites, access through kiosk, telephone, fax, mail or any equivalent; an infrastructure that is flexible/expandable to support future growth and changing business needs (e.g., support to both existing and future loyalty programs, and existing and future member account information such barcodes, magnetic stripes, etc.); enrollment of members to their unified card information stored at the provider's databases; management of the data stored at the provider's databases, order data tracking to allow customers to monitor the delivery and status of their order; electronic mail order and status confirmation capability, etc.

The present invention also optimizes and maximizes the interaction between the member and third party businesses, since loyalty programs cards are often forgotten once members are at the third party business who originally issued them. Due to the high quantity of cards carried, sometimes customers tend to leave some or all his/her loyalty cards in their cars or at home. To that extent the unified card is an opportunity to increase the relationship in the loyalty industry, since it will always be present at the clients wallet/personal belongings due to its easiness to carry. The ability to integrate several loyalty programs into a unified media, as at 100, is likely to increase enrollment and usage of the loyalty services that are being exposed to the customer.

As will be appreciated by one of ordinary skill in the art, the present invention makes use of one or more of data processing systems, devices for data processing, computer program products. Accordingly, the present invention may make use of an entire software embodiment, an entirely hardware embodiment, or an embodiment combining aspects of both software and hardware. Furthermore, the present invention may encompass a computer-readable storage medium having computer-readable program code means embodied in the storage medium. Any suitable computer-readable storage medium may be utilized, including hard disks, CD-ROM, optical storage devices, magnetic storage devices, or other similar device.

There may be communication between the provider and the client accomplished through any suitable communication means, such as, for example, a telephone network, Intranet, Internet, point of interaction device (point of sale device, personal digital assistant, cellular phone, kiosk, etc.), online communications, off-line communications, wireless communications, and/or the like.

Databases, systems, or components concerned with the present invention may consist of any combination of databases or components at a single location or at multiple locations, wherein each database or system may include any of various suitable security features, such as firewalls, access codes, encryption, de-encryption, compression, decompression, and/or the like.

The client or member, the provider and third party businesses may be individual persons, entities, or business. Although discussed as loyalty unified card, this unified card 400 may represent other types of information in addition to barcodes and magnetic stripes 410 of loyalty programs, such as personal information, medical information, emergency contacts information, and any other type of information capable of being stored within the unified card 400. It is further noted that other participants may be involved in some steps of the transaction, such as an intermediary settlement institution.

The computing units are or may be connected with each other via a data communication network. The network may be a public network and assumed to be insecure and open to eavesdroppers. In the most common embodiment of the invention the network is embodied as the Internet. In this context, the computers may or may not be connected to the Internet at all times. For instance, the customer computer may employ a modem to occasionally connect to the Internet, whereas the provider computing center might maintain a permanent connection to the Internet. It is noted that the network may be implemented as other types of networks, such as an interactive television (ITV) network.

An electronic commerce (e-commerce) system, may be used in support to the inventions. In an exemplary implementation, the electronic commerce system is implemented as computer software modules loaded onto the providers' computer system. The client computing system may, preferably, not require any additional software to participate in the online commerce transactions supported by the online commerce system. The e-commerce system may be responsible for guarantying the security of confidential information, such as credit card number, and other personal information, during its communication and transit from the end user system (client's personal computer, kiosk, etc) to the provider's main databases. All references within this invention/document to existing programs from other companies, in written or through images, were merely illustrative for the only purpose of helping describe this invention. Any brand or logo illustrated or mentioned on this document that recalls or belongs to other parties were used for the solely purpose of illustration. Products, brands, names and/or logos referenced herein are either trademarks or registered trademarks of their respective owners. Other product and company names mentioned herein may be the trademarks of their respective owners.

The appearance of any advertisement or specific company logos/trademarks herein is not an endorsement of this invention or its inventors by said advertisers or owners of said company logos/trademarks.

1. Method of unifying two or more loyalty programs in one single media, according to the following steps, wherein:
a. contact is established between a client and a provider of unified media;
b. said client provides personal identification and his/her third party loyalty programs to be unified, to said provider;
c. said provider provides identification means for said client;
d. said client provides the means that contain data related to the loyalty programs to said provider;
e. said provider unifies information on a unified media;
f. said provider provides unified media to client

2. Method according to claim 1, wherein said unified media is a card, particularly, of the shape and size of a regular credit card.

3. Method according to claim 1, wherein contact between client and provider is one or more of personal, by mail, by telephone, through a network.

4. Method according to claim 3, wherein said network is the internet.

5. Method according to claim 1, wherein personal information in step “b” is one or more of name, address, telephone, e-mail address, social security number, bank account number.

6. Method according to claim 1, wherein the identification in step c comprises a login name and a password.

7. Method according to claim 1, wherein the means that contain data related to the existing loyalty programs to unify are one or more of cards, barcodes, numbers associated with barcodes, magnetic stripes, chips, RFID tags.

8. Method according to claim 1, wherein in item f the provider provides unified media to the client by local manufacture, delivery by mail or personal delivery.

9. Method to change status of pre-existing unified media, comprising the following steps, wherein:
a. contact is established between a client and a provider of pre-existing unified media
b. said client inform the wish to include one or more loyalty programs in the unified media;
c. said client provides the means that contain data related to the new loyalty programs to said provider;
d. said provider unifies information on a unified media;
e. said provider provides unified media to client
f. said provider provides unified media to client

10. Method to change status of pre-existing unified media, comprising the following steps, wherein:
a. contact is established between a client and a provider of pre-existing unified media
b. said client informs wish to exclude one or more loyalty programs, or information, from the unified media;
c. said provider unifies remaining information on a unified media;
d. said provider provides unified media to client.

11. Method according to any of claims 1, 9 or 10, wherein before the provider provides the unified media to the client, or before the provider unifies the client's information on a unified media, the provider prompts the client to review and approve his/her request and/or to provide advance payment or any other form of payment.

12. A unified media wherein it contains identification means of at least two loyalty programs, available for a user who possesses such unified media, to be used in connection with the at least two loyalty programs.

13. A unified media according to claim 12 wherein said unified media is a card of size and shape of an ordinary credit card.

14. A unified media according to claim 12 wherein it contains more than three, or more than 4 or more than 5 unified loyalty programs.

15. A unified media according to claim 12, wherein it is associated with a cover sheet mask comprising a window to allow only one specific barcode or magnetic stripe to be read at a time
